(19) United States
(12) Patent Application Publication
(10) Pub. No.: US 2017/0216728 A1
(43) Pub. Date: Aug. 3, 2017

(54) AUGMENTED REALITY INCORPORATING PHYSICAL OBJECTS

(71) Applicant: Twin Harbor Labs LLC, Plano, TX (US)

(72) Inventors: James Logan, Candia, NH (US); Sean Joseph, Windham, NH (US); Richard Baker, West Newbury, MA (US); Sam Murley, Dubuque, IA (US); Julia Logan, Candia, NH (US); Morgan Logan, Candia, NH (US); Sydney Sieper, Manchester, NH (US); Coleman Sieper, Manchester, NH (US)

(21) Appl. No.: 15/418,382

(22) Filed: Jan. 27, 2017

Related U.S. Application Data
(60) Provisional application No. 62/288,948, filed on Jan. 29, 2016.

(51) Int. Cl. A63F 13/65; A63F 13/58; A63F 13/213

(52) U.S. Cl. CPC A63F 13/65; A63F 13/213; A63F 13/58; A63F 2300/8082

(57) ABSTRACT

An augmented reality game is described that incorporates the physical environment of a room and a set of game objects such as toy soldiers. The physical environment and the game objects are loaded into the game, and the player conducts the game play by moving the game object while the computer simulates the action. The player has the ability to manipulate time as well as the physical environment and game objects as the game is played.

### RELATED APPLICATIONS

This patent application is a non-provisional application of, and claims the benefit of the filing dates of, U.S. Provisional patent No. 62/288,948, filed on Jan. 29, 2016, entitled Augmented Reality Incorporating Physical Objects. The disclosures of this provisional patent application is incorporated herein by reference.

### BACKGROUND OF INVENTION

Field of the Invention

The present invention is directed to computer gaming utilizing augmented reality, in particular gameplay that dynamically incorporates physical objects into the virtual game.

### DESCRIPTION OF THE RELATED ART

As video game technology has progressed from simple 8 bit arcade games to high end cinematic experiences, much of the possible game scenarios have already been explored. In this modern age of remakes and remasters, things that were once novel and entirely unique are now becoming rote and formulaic. In stark contrast to that stagnating landscape, augmented and virtual reality present exciting new possibilities for video games. In 2016, technology has finally caught up to the 70+ year old vision of a completely virtual world, and developers are starting to flock to the new wild west of video games. High end consumer oriented augmented and virtual reality devices are only months away from hitting the market, and a scramble has developed to begin finding applications for the new hardware in video games, and everyday life.

Augmented reality devices are devices equipped with a screen, a processor, and a suite of sensors. These components work in tandem in order to overlay a virtual augmentation over top of the real world as viewed through the screen. Virtual reality devices, on the other hand replace reality with a simulation instead of augmenting it. These devices can range from the very simple, to the very complex. At the simple end of the spectrum, a smartphone, or a laptop, can be considered to be augmented or virtual reality devices. However, those devices were not designed expressly for the purpose of use as reality-altering devices. On the higher end of the spectrum, products like HoloLens and Oculus Rift are about to make their debut. These devices are incredibly powerful, and optimized with the express purpose of presenting the player with an altered-reality. These new, powerful, and high end devices mark the beginning of a new age in gaming.

This augmented reality game aims to be the first to implement a key set of novel features relating to the interaction of the virtual world and the real world, and the augmentation of the real world with the virtual. Though the game is largely intended for higher end reality-altering devices, it should function with a limited feature set on any device with the proper components; namely a processor, sensors, and a screen. Described herein is the novel feature set and the technical requirements to implement them.

With the emergence of technology such as Augmented Reality, Virtual Reality and computer vision organizations and developers of the technology alike are being challenged to connect the physical world with digital counterparts. Traditionally, this type of connection has to be programmed by hand by computer programmers and hardware engineers to convert physical objects and actions into logical programming language to support custom applications.

The expertise required to translate physical objects into digital counterparts is usually handled in the industry on a case-by-case basis based on the use-case and overall application functionality. A standard protocol has not been developed to govern and guide the integration constraints applications can leverage to properly and immersively connect physical objects with digital components.

### BRIEF SUMMARY OF THE INVENTION

This invention utilizes an augmented reality device to transform real-world objects into a virtual world, where games and simulations can take place bringing these real-world objects to life.

### BRIEF DESCRIPTION OF THE DRAWINGS

FIG. 1 contains a set of army men that could be used for the game play.

FIG. 2 is a photo of army men setup in a natural environment.

FIG. 3 is a photo of a set of army men set up in an environment designed for game play, with various props.

FIG. 4 is a photo of a piece of furniture, specifically a chest.

FIG. 5 is an instance of the chest as transformed by the software into a building.

### DETAILED DESCRIPTION AND BEST MODE OF IMPLEMENTATION

Described herein is a game for playing with physical toy soldiers in a physical room, where a computing system views the game play utilizing one or more cameras, and incorporates the toy soldiers and the room characteristics into a virtual game. The toy soldiers essentially become an input device for the game. While we focus our description here on toy soldiers, it is envisioned that this concept could be used for a number of other methods of play, such a toy trucks, fire engines, dolls, and other methods of play. Multiple children themselves could be the game objects, with the virtual work modifying the period of their clothes and the characteristics of the room.

### I. Technology

A. Hardware

Though more complicated augmented reality devices add more complex capabilities to the game design, any set of devices consisting of a camera, a processor, and a screen would be sufficient to run an iteration of the augmented reality game described here. For example, a simple laptop could run the game, and though it would not be able to utilize all of the features described herein, it would have sufficient capabilities to generate an engaging experience for the players.

1. Minimal Hardware

In a minimal hardware iteration of the game various features of the main game would need to be omitted, but several of the core concepts could be retained. “Minimal hardware” refers to hardware that is technically capable of running augmented reality processes, but does not possess the raw processing power to operate the game at full scale. An example of minimal hardware would be any smartphone manufactured since approximately 2010. The smartphone would be capable of recognizing the input device (the toy soldier, or truck, etc.) and animating it, but it would very likely be incapable of completing this for every input device on the map at once. In addition, the device would likely be incapable of determining if a soldier's fire had hit the enemy successfully, but could simulate the firing, and leave the decision regarding whether or not it hit successfully up to the player. It is anticipated that future smartphones will have the processing power to fully implement the functionality described herein. Additional capabilities and limitations are highly dependent on the specific hardware specifications of each device, and cannot be assumed generally.

2. Maximized Hardware

With ideal hardware, very likely a few years from now, there would be little to no limitations to what the toy soldier game could do. Such “ideal” hardware should be on the market within a few short years as long as technology continues to improve as it has. With a powerful enough processor and precise enough sensors, the number of soldiers the device could recognize and render on a battlefield would essentially be infinite, and all features could be implemented as described.

3. Current Hardware

Currently, there is a suite of devices preparing for launch for consumers. The majority of these devices are considered to be virtual reality, with the exception of Microsoft HoloLens, which is augmented reality. These devices contain roughly equivalent processing power and feature sets. As such, we would see very similar iterations of the toy soldier game across the different platforms. Because some of the devices have yet to release the required specifications for running their hardware, anything beyond estimation of technical capabilities would be pure conjecture. However, based off of the information that is available, the augmented reality game should be able to be run with all features intact while creating a good visual experience. Note that there will be limitations to the number of soldiers which can be rendered, and also how frequently the soldier firing trajectories can be refreshed. These limitations are dependent on the optimization of the game with the system it is running on, but it is not unreasonable to expect a good quality experience on these high end devices.

4. HTC Vive, Oculus Rift, or Sony Project Morpheus

The HTC Vive holds one feature that all other current virtual reality players are lacking. Whole room position tracking on the HTC Vive allows for players to use the whole room as the setting of any virtual reality game, and allowing the player that freedom of motion is pretty important for a game which requires use of a whole room. Note that other virtual reality developers have expressed an intention to at a later point develop full room virtual reality.

The Oculus Rift product can be seen in US Design Pat. No. 701,206. It requires a NVIDIA GTX 970/AMD 290 equivalent or greater graphics processor, an Intel i5-4590 equivalent or greater processor, more than 8 Gigabytes of RAM, a compatible HDMI 1.3 video output, two USB 3.0 ports, and a Windows 7 or better operating system.

NVIDIA is also creating products in the virtual reality space that may be using to implement the toy soldier game. See US Patent Publication 20150138065 for a description of the NVIDIA product. Sony's work in this area can be seen in US Patent publication 2014/0104143 and 2011/0248904. Sony requires a Play Station 4 to work with their devices.

B. Soldiers

The soldiers could be normal green army figures commonly sold in various locations or could be action figures with moving arms and legs. They would not necessarily need any specific indicators to be recognized by the augmented reality device as soldiers, but they could be chipped as well. Additionally, dolls, trucks, ships, or other toys of pretty much any source could be used in place of soldiers for various different iterations of the game.

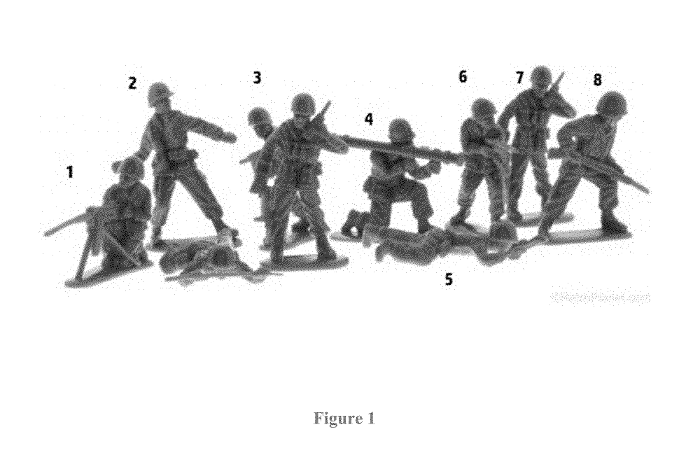

As can be seen in FIG. 1, the toy soldiers are unique, each holding a different weapon, and meant to fill a specific role. Upon being animated, each of these soldiers would continue to fulfill the role designated by their design. Soldier 1 is crouched and is using a heavy machine gun. This sort of weaponry would be ideal for use at medium range against infantrymen, but would fail miserably at long range. Soldier 2 is in the process of tossing a grenade, while animated, the soldier would not maintain a mid-throw position, and would be made to appear as standing up, however, when engaged in a fight the soldier would pass through that pose in order to make the grenade throw. Soldier 3 is using a submachine gun, and is very agile because of it. This agility makes the soldier ideal at closer ranges. Soldier 4 is equipped with a rocket launcher. This rocket launcher soldier would likely be of most use at extended range and against other artillery equipped soldiers. Soldier 5 is prone, engaged in an army crawl with a rifle. Once again, when firing, the soldier would be animate to aim the gun before firing. Soldier 5 is very useful for stealthy maneuvers, being able to stay low may allow the soldier to remain unseen by the enemy. Soldier 6 is another submachine gun user. While both soldier 6 and soldier 3 are technically exactly the same, upon being animated they would have different facial features and would be unique individuals. Soldier 7 is a radio controller (there is another radio soldier stacked upon soldier 3) these radiomen could be used as relays to communicate commands to troops, this communication is required in a real battle before making maneuvers, so to increase the realist nature of the battle realistic communication channels could need to be used to engage in maneuvers. Soldier 8 is standing with a rifle, riflemen are generally most effective at moderate to longer ranges than up close.

C. Environment

The environment of the game is highly dependent on the player's environment. Rooms, outdoor spaces, hallways, all these things are acceptable settings for the battlefield. Additionally, props could be placed on the map in order to modify the environment. Things like snipers nests, forts, and other tactical structures could be purchased separately and used to augment the battlefield. These pre built structures could be sold separately as an additional revenue stream. Purchased pre built structures could also offer better stats to the soldiers using them. For example, a set of soldiers using a box as a fort would see worse results than a set of soldiers using a fort as a fort.

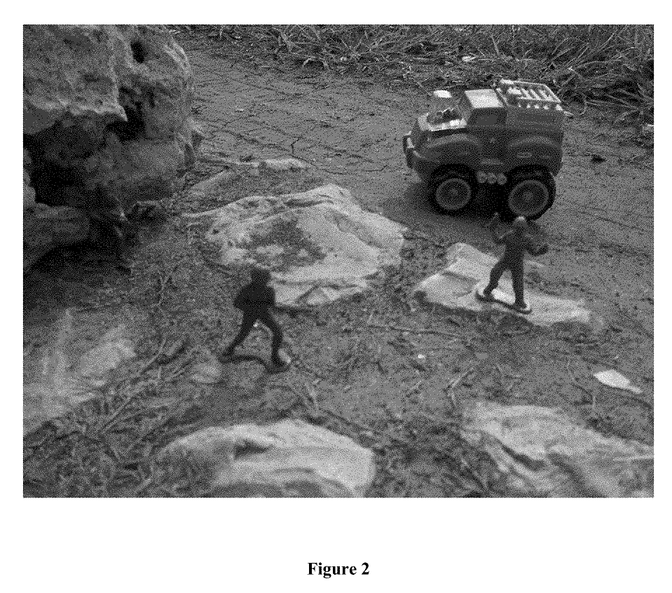

FIG. 2 is a photo of army men setup in a natural environment. The virtual software would take the stones and grass and convert it into cliffs and brush.

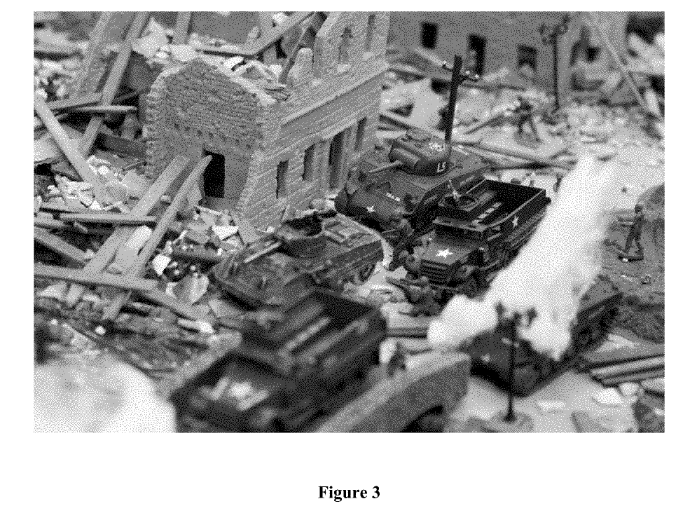

FIG. 3 shows a different type of game play, utilizing more sophisticated and custom props for the soldiers to be set up in. Here the bombed building are purchased and miscellaneous debris is added. The virtual toy soldier game takes this environment and converts it into a virtual world that resembles, but enhances, the physical setup of the soldiers.

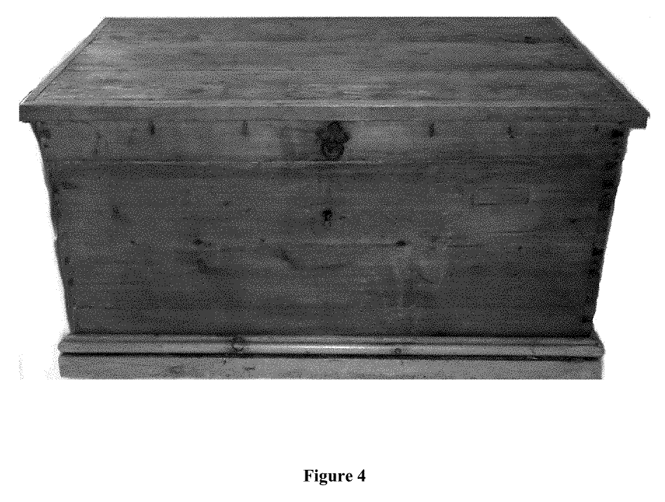

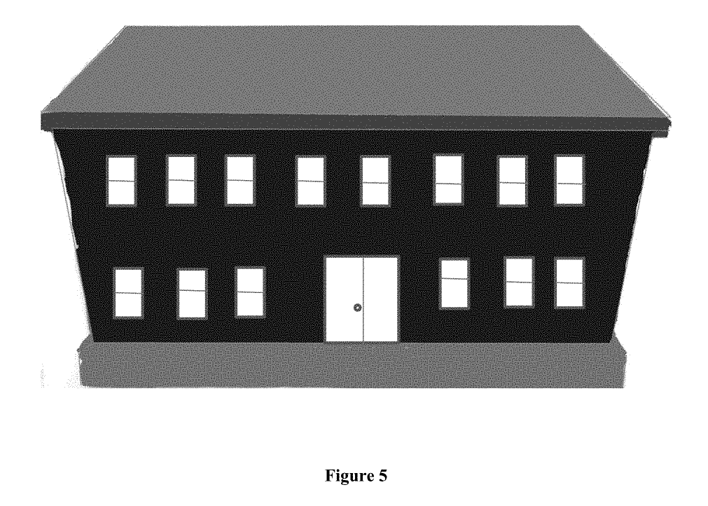

In FIG. 4 and FIG. 5 one can see the transition process from real objects (FIG. 4) into digital artifacts (FIG. 5). The invention takes note of the dimensions and even attempts to make decisions regarding the object's composition and then overlays it with a digital rendering of the same geometry. This rendering retains as much information as the system could discern about the object including dimensions, orientation, composition, and based off of the composition data the invention can make determinations about how other digital objects would interact with the object in question. An example of the relevance of this data is how a digital toy soldier would react to being placed on this object. Because the box is wood, and has a flat horizontal surface, the soldier can be placed directly on the object and will stand and be capable of engaging in fights. However, if the box was instead made of cardboard, the soldier would react far differently to the object, it would not be able to stand on the object and fight, it would instead fall through, or become unbalanced.

D. Computer Devices

The computer could be a PC, a tablet or a smartphone with at least one camera capable of capturing video with reasonable resolution. In addition, there should be a fairly high resolution screen and a pointing device such as a mouse and/or a touchscreen for modifying the screen. When using a smartphone, the player could use a 3D cardboard cell phone holder such as a Google Cardboard device. Alternatively, the player could use a complex augmented reality device such as a HoloLens or Oculus Rift.

E. Software

The software engine for the invention includes computer vision technology, and specifically uses object recognition and physical terrain mapping to anchor the placement of the soldiers from the physical environment into the digital scene within the application. The software scans the room environment and recreates a physics-based mesh for digital interaction within the application, transforming physical objects such as books into buildings, piles of clothes into mountains, etc. The software supports battle gameplay and simulation, incorporating the ability to play, pause and stop gameplay as well as the ability to dynamically change anchored content. Players of the game software are able to interact with and manipulate the digital assets through the device and through hand-gesture recognition.

The software incorporates functionality to collect the input from multiple cameras and/or multiple images of frames of the environment, and then to mesh these images together into a 3D virtual model of the physical environment. The software will store this 3D virtual model instance and update the model over time as the physical environment changes. By storing either the entire model at various points in time (on each change, perhaps, or periodically), or by storing the changes that occur and a timestamp of changes, the software maintains the ability to move forward or backwards in time to the physical environment at any point in time.

### II. Gameplay

There are multiple phases that make up the gameplay. First, the game requires a certain degree of setup. This setup phase is then followed by a loading process which will introduce the digital components into the gameplay. Finally, the game will begin properly, as the actual simulation of fighting occurs during the simulation phase. Lastly, during and after the simulation phase, the Augmented Reality game is capable of resetting the simulation to a previous point in the combat.

A. Setup

The first phase, the setup phase, consists of a few distinct, but necessary processes which occur in order to prepare the game to be played. Without a certain degree of setup the Augmented Reality devices being used by the player would not have sufficient information in order to properly execute some of the features of the game in the later phases. These processes affect a major component of the game. The game map, the setting of the game and the space occupied by the player, undergoes a few processes to prepare.

1. Game Space

The dynamically generated environment can usually be considered to be a partial or entire map of the room which the player occupies. However, this is somewhat dependent on the shape of the room. For example, if the player occupies a room in a “C” shape, the player will not be able to manage all soldiers at once. So, to revise the initial statement about the game map occupying an entire room, the game map would be considered to be all the space which is visible through the user device (with or without rotating) while the player is in the center of the room. This generated plane is considered to be all of the space where dynamically generated physical objects can be placed and recognized by the software.

a. Room Measurements

During the setup phase, the Augmented Reality device running the game software requires that measurements are taken so that it can properly determine the dimensions and depth of the physical environment and objects from the user device. These measurements could be taken fairly easily by having the player view the room from various different perspectives using the game software. These various viewpoints in the form of 2D images would be taken into account and the software would then use those viewpoints to understand the space it is occupying and recreate a physics-based digital representation. The software will also leverage depth sensor hardware to create depth maps and instant mesh scans from these various locations to collect physical object textures and precise measurements. Once the software has collected the two-dimensional and depth data from the space it is occupying, the software can then recreate a light-weight terrain map for interaction with other digital components. Through the software, the space the player occupies will be marked in some way to designate it as the useable game map. There are several different equally acceptable methods for designating the physics-based map using the software as separate from the rest of the house. One manner of delineating the occupied room is by using a slight hue to overlay the occupied space. Another method is to mark off the outer boundaries such as doors and windows so it becomes obvious that only the occupied room is playable space. This marked off space then becomes the game map. The captured area is considered to be “in bounds” and is usable by the player. This captured area can be an entire room or subset of the room. Physical objects within the device view are also collected and recreated by the software as bounds and serve as a method for creating greater intricacies and interactivity to the simulation. This is similar to the imaginary army games played by children, in that any space can become the battlefield.

b. Terrain Measurements

The terrain that is generated by the software is a key aspect and the foundation of the software as well as a key aspect and input for the simulation. The player would be free (initially) to place any physical object like chairs, books, tables, or really any household items wherever in view to generate a precise and accurate digital terrain mesh. This is similar to the dimensioning of the simulation boundaries, and creates the interactive terrain with varying vertical and horizontal depth based on physical objects in the scene. The measurements would once again be taken by viewing the room from various perspectives with the software using two-dimensional images as well as depth data collected from a depth sensor. See FIG. 4 and FIG. 5 as an example of how a physical object, a chest, may be converted by the software into a building in the virtual world.

Placing physical objects into the game map for terrain generation such as cans, books, and all other household items is useful because it creates a more intricate environment for the digital content during simulation, therefore making the gameplay a more engaging experience for users of the software. This environment manipulation by the user would typically occur during the setup phase because most players consider the landscape to be stable, however the game is capable of noting adjustments in terrain during later phases, and reacting accordingly. For a very creative user, the ability to part the waters of a sea or to make a mountain come up out of the sea makes for an interesting game play.

2. Physical Object Placement

During the setup phase, the player would not yet be prompted to add soldiers to the battlefield until after both room measurements and terrain measurements have already taken place and loading in has begun. Note that while the player will not yet be prompted to position soldiers, they are free to do so and it will not cause interruption of the game setup. This is because the Augmented Reality first gains an understanding of the full extent of the battlefield before registering the soldiers that occupy it. Once these measurements have been made, and the load in phase has begun and the player will be prompted to place soldiers. Soldiers can be placed all around the map and the Augmented Reality device will be able to determine their location with respect to the battlefield and with respect to other soldiers.

a. Physical Object Placement

The software allows players to place objects within the physical scene prior or after room measurement and terrain generation procedures. The software is unique in comparison to the teachings of others in that it can fill in the digital map if connection points are not visible between the computer device running the software, physical objects and generated boundaries. The physical objects can be moved and the software is also unique in comparison the teachings of others in that it can recognize moving physical objects from the boundary and simulation terrain. Once these physical objects are differentiated, digital content anchored to these objects will also stay placed with the origin of the physical objects.

B. Load-in Phase

The Load-in phase consists several processes which complete the recreation of physical objects into digital representations through the software. In one, the software processes the translation of the game map from an assortment of real objects into digital versions for further simulation and interaction. The capture and digital generation process also takes into account the translation of the transform (position, rotation and scale) of the physical objects into digital versions. Soldiers from simple purely physical, unmoving game pieces, into a virtual fighting force full of vibrant characters. Additionally, the type of combat must be chosen from a list of several options.

The real power in the augmented reality game lies in the novel systems it draws upon. The system for generation of interaction metadata from physical object properties is the next step in virtual reality and augmented reality. The system draws conclusions about the physical properties of the objects it recognizes while also working to make determinations between the digital artifacts generated by the game and the physical world.

1. Translation of Game Map from Real Objects to Game Terrain

In combining the digital world with the physical through the software, the goal is to create the atmosphere of a battlefield to create a realistic experience for the player, but to also preserve the true geometry of the battlefield. This way, the experiences generated by the software can be created, and digital positioning in the simulation scenes will still directly correspond with real-world positions. To explain further, the transform (position, rotation and scale) of every object as generated in the digital space will be preserved. The software tracks the location where objects are placed at the ground level and anchors the digital version into correlating positions. The software essentially recreates the physical objects and re-textures from the base physical geometry. The software will use algorithms to determine the perspective and layout of objects in terms of characterizing the object as portrait, landscape or cube-based primitive. A vertically oriented object would be collected and recreated in the simulation space as an object with mirroring height based on the ratio and simulation area dimensions. The software also supports the inverse. Areas that are deemed to be low points or pockets are regenerated as such in the software's simulation algorithms. A can of coke could be colored like a mountain, or a castle, and deep trenches would become rivers and lakes. It is important to note that while the textures of objects are feasible to change, false terrain generated digitally (like a classic mountain) would ruin the battle to a certain degree, as the real toy soldiers cannot be placed on terrain that does not exist. Additionally, the set of various textures which could be used could vary with the time setting of the battle. In medieval times terrain would be visualized by castles and catapults and such, while in modern times they would be visualized by air bases, or cities.

The determination of which texture to be used for which physical object texture file is handled by the software by allowing the players to customize and choose textures and also by using the algorithms to dynamically texture the physical object's digital twin counterpart based on physical size and distance from the computer device. The simplest implementation it to give the player access to a list of textures, and allowing them to choose any texture for any object. Another, more technically difficult way, is by using artificial intelligence to estimate based off of the shape of the object which texture is most fitting. An example of this second method is that an Augmented Reality device could recognize that objects of boxy shape (like a box) make a good estimation for a castle, so the device would automatically apply a castle texture to that object.

2. Soldier Positioning

The initial transform (position, rotation and scale) of the digital representations plays a significant role for the software in determining physics interactions within the simulation. The software is unique in that it will create and attach metadata to the digital representations based on a number of physical factors. The metadata created by the invention will govern interactions between digital assets and physical boundaries. The metadata will also govern how digital assets can interact with these physical boundaries and physical objects. This metadata includes but is not limited to: health, enabled/disabled, visible/invisible, likelihood of success when interacting with other digital assets, distances from other digital assets, physics interaction with other digital assets including boundaries, orientation in world coordinates, line of sight with other digital assets and trajectory arc between digital assets as a one-to-many relationship.

This metadata is formalized by the software and shown visually to the end user as Augmented Reality content for further decision making and engagement by the end user.

Soldiers' likelihood of success in real engagements is based in no small part upon their strategic positioning. Probabilistic outcome algorithms would be built into the software to determine the probability of hitting an opponent based on the positioning, the type of weapon, distance from the target, etc. The Augmented Reality soldiers would similarly gain benefits from being in strategic positions (infantrymen 8 granted some sort of bonus when arranged in formation, soldiers gain the advantage of high ground when above, advantage of cover from enemy fire, etc.). Additionally, soldier positioning must take terrain into account, a soldier cannot shoot through a wall for example. Range values will also play a large role in the successfulness of the soldiers.

How the soldiers are oriented also plays a significant role when placing the soldiers. Line of sight is necessary for fighting enemy soldiers, so the player should attempt to make at least one line of sight connection for all soldiers. Certain soldiers, (see FIG. 1) such as those with grenade launchers 2 or artillery units could perhaps avoid the line of sight requirement because of the arc like trajectories of their weapons. It is feasible for a trajectory marker to be created virtually by the soldier. This guiding line can be used to aim the soldier at an enemy combatant. While loading in and placing soldiers this guiding line would prove to be useful with strategizing soldier placement, being able to see where exactly your soldier is aimed makes it much simpler to aim.

Toy soldiers are generally not all the exact same. The toy soldier game will capitalize on each soldier's uniqueness for two reasons. The first reason is to promote character development, if each soldier is unique the player can develop an attachment to specific soldiers which enhances the experience. The second reason is to allow for intricacies in combat, giving some soldiers access to rocket launchers 4 while others use handguns makes for a far more complicated strategy. Even artillery like tanks or battleships could be used in battle. The different soldier specialties have a profound effect on what their optimal positioning would be. For example a soldier with a sniper 5 should be positioned far away from the front lines. Soldiers of differing types could be sold in packs, thereby giving the player access to additional armaments while also funding the game.

a. Sister-Proofing

Real world toys are often at a disadvantage to digital toys in the modern age, one reason this is the case is because physical toys occupy space, and require cleanup, sometimes even before the game is properly finished. In stark contrast, all digital games are equipped with a save feature, allowing you to save the state of your game, and return to it at a later point. The toy soldier game employs a similar principle to the digital “save game” feature. After soldier placement has been completed, soldier positions and orientations are “saved” by the Augmented Reality device. By saving this information, accidentally moving a soldier (or having a sister interfere with soldier positioning) does not spell disaster for the battlefield. This can also be used to save the state of the game in the event that a pause is required, or if the soldiers need to be cleaned up for any reason, they could be replaced later. This means that game lengths are not limited by how long parents will allow for the toy soldiers to be setup, and can span multiple play sessions.

The software employs what is called continuous site synchronization and recall. This unique differentiator allows users of the software the ability to save the digital representation of the generated simulation for future recall and re-mapping at various points during the simulation. This information is saved locally on the device as well as through a client-server architecture, if one is employed. The software site recall feature allows the end user to load previous simulation layouts and map them into their physical space through the use of computer vision and depth mapping. Digital location points with object descriptors will show for each digital twin representation based on the state of the physical objects during the previous simulation session. These descriptors are used as a visual guide for object placement in terms of continuing the simulation from a previous save-state. For instance, ghost shadows could be displayed on the screen where each inadvertently moved soldier was located so that the players can reassemble the soldiers at their location at the selected time.

3. Opponent Soldier Positioning

At this point in the game setup it is time to pick which type of play to engage in. There are a few different options depending on the number of players and whether or not they are physically located in the same place or have to play over the internet. Depending on which type of play the player chooses, the game will have differing boundaries and rules. These different regulations ensure that regardless of how the gameplay situation a fair and engaging game can be completed. Players can either play against a computer, or play against another player. When playing against another player either both players can be in the same location, or a game can be played over the internet. In all the different iterations of play, a winner would be decided when all of the enemy's soldiers have been defeated.

Often times, when no one else is available to play, the player decides to play against an artificial intelligence (“AI”) opponent. In fully digital games this is fairly simple to achieve, but when the game exists in both the physical and virtual space, it becomes more complex because the computer cannot physically move soldiers. When playing against a computer, the player will be responsible for the movement of both teams' physical soldiers. What this means is that while both the player and the computer will make choices regarding how to maneuver their soldiers, the player is responsible for physically moving both. Additionally, while playing against a computer, the game map may be divided into two separate parts so each combatant has control over one half of the battlefield. When playing against an AI opponent, another option is to make the enemies physical soldiers unnecessary, so instead the AI would utilize virtual soldiers, and the player would only be responsible for moving their physical soldiers. The processes required to achieve fully virtual soldiers are similar to the rendering over the physical soldiers the player uses, but without a physical counterpart.

In one embodiment, when two players play against each other while in the same location, the game map could be divided into two sides, like when playing against a computer opponent or when playing over network. Each player would have command of their soldiers and be allowed to place their soldiers anywhere. The dividing line would be agreed upon by both players, and drawn up using the Augmented Reality devices. This dividing line could be rendered in the room using any Augmented Reality device and used as a reference during the battle so neither player sends soldiers outside of their allowed zone.

Alternatively, the players could intermingle their players on setup provided that the physical players are distinguishable by the software (for instance, one set of toy soldiers are green and the other set are brown).

Unlike when playing against a player over network, if desired by the players, opposing soldiers could cross the boundary lines in assaults into the other player's battlefield. In this type of engagement when both players are in the same room a different game type could be played where instead of trying to simply destroy the opposing force the goal could be to capture a flag in the opposing base.

HoloLens, and other virtual/Augmented Reality devices, have established that a flat wall can have an image “projected” onto it in order to simulate another player's game map, using this established method, two players not residing in the same physical location can play together collaboratively or competitively over the internet. In this iteration of the toy soldier game, all actions would be the same as if the player was physically there as well. In this iteration the “dividing line” is the wall, and obviously no player can place soldiers across a boundary they cannot physically cross. There are some limitations to this specific method of multiplayer. One limitation is that the size of the “portal” the Augmented Reality device generates into the other players game map is bounded by the size of the flat wall the player is projecting upon. So, if one player is playing in a long and narrow room, while another is playing in a short and fat room, the gameplay maps will not match up, essentially ruining the gameplay. When two player controlled armies wish to fight from different locations it does add a level of complexity to the technical requirements of the fight, the two game maps need to be of similar size and terrain in order to ensure fairness. Additionally, in order for a virtual reality device to project an image of another room onto a wall the wall must be flat, without complex features or wallpapers. Along with this virtual projection of the other player's location, the device must also continue to simultaneously render the soldiers, and must continue to make line of sight calculations.

The toy soldier game works to present a game that is fair regardless of external circumstances. This means that when two players are playing in rooms of different sizes, the system needs to equalize the playing field. This can be done in a few separate ways, one of which is only using a subsection of the larger room, and another is resizing the smaller room to match the larger one. Regardless of the manner of equalizing, it will still be necessary for the system involved to have systems designed to recognize the inconsistencies between players' rooms and rectify them.

a. Multiplayer and Networking

The software supports different simulation modes as well as networked multiplayer interaction. Depending on the physical location of each player the game software can support different engagement options. If players are not physically co-located in the same space, the software takes that into account and requires the players to map similar spaces in terms of bounding size and scale. The software employs low and high thresholds on vertical and horizontal planes as distributed playing spaces may not be exactly the same. If the players are located in the same physical space, the generated simulation boundaries will be captured by one of the players through the software and the additional player(s) enter the same simulation scene from their unique perspective. In both instances, a client-server architecture is leveraged through the game software to connect players into the same digital space.

b. Artificial Intelligence (AI)

In the event a player wishes to interact with a generated simulation but no other players are available, the game software supports a computer vision machine learning algorithm to support interaction. The software employs the same techniques for AI inputs but placement and interaction algorithms are used by the software for AI dynamic response and engagement with end-users digital content and changes to their digital assets.

4. Hand Mapping and Gesture Interaction

In order to maximize the player input and interaction with digital assets, the software also maximizes the response and haptic feedback. The software is unique and different from the teachings of others in that it employs a hand-ghosting effect when one or more player hands are in front of the device running the game software. The hand of the player can obscure the digital assets when between the device running the game software and the digitized representations of the physical objects, hiding important asset placement information. In order to improve the quality of interaction, the software will recognize when one or more hands are in view and the software dynamically textures the hand with a translucent digital material so that the player of the game software can still determine spatially where their hand is placed in relation to the digital assets in the simulation. This is unique in terms of differentiating from the teachings of others. The software ensures that the hand becomes translucent and not entirely transparent because being able to see the hand is also important when interacting with digital objects. The game software allows the player to view the entire simulation space while still being able to use their hands to either place/orient objects or to make gestures to interact with the simulation user interfaces. The implementation of this system draws upon object recognition technology, augmented reality technology.

The software leverages devices equipped with depth sensors and infrared sensors to accurately track one or more hands when in view. The software supports other types of interactive user input such as touch and voice-commands. While the teachings of others focus on the hardware to support such interaction, this software focuses on unique and user-friendly algorithms to support gesture and audio interaction.

Augmented/virtual reality devices almost ubiquitously come equipped with various recognized commands incurred by gestures, or sounds. These device-determined inputs would be utilized by the toy soldier game to allow the player to have control over battlefield settings among other useful controls. For example, a setting could be mapped to a swipe, by swiping the player could change the time period of the fight, causing new skins to be placed over the soldiers. In this way, with only a single swipe, soldier uniforms could change from civil war, to modern. Mapping these settings to gestures and sounds frees up the player to make these changes mid-battle without losing wasted time inputting them into a computer or other traditional digital device. This would allow a battle to be started in medieval days, convert to Revolutionary war costumes and characteristics, and finish with a World War II theme.

C. Simulation Phase

After loading in is completed and all soldiers are placed to the satisfaction of the combatants, the simulated battle can begin. Immediately upon beginning the fight, soldiers will begin firing and players will start making tactical adjustments of soldier positioning to try and turn the tide of battle to their favor. Depending on the specifics regarding which game mode the combatants are playing, the battle might play in a few different ways.

1. Battle

a. Soldiers

Once the fight simulation has begun the soldiers will spring to life on the Augmented Reality device screen. Their unique appearance and specialized weaponry will become immediately apparent. Moving physical soldiers will cause running animations as they move to the new location where the soldier has been place. Allied and enemy soldiers will also begin to fall wounded/killed as both sides try to take each other out. During the battle the soldiers on the battlefield will come to life through the “eyes” of any Augmented Reality device. The soldiers themselves will also be employing some artificial intelligence. Firstly, they will do as their commanding user dictates, and secondly the soldiers will attempt to defeat the opposing force.

Soldiers will also have an augmented overlay giving feedback to the player when they are injured/killed. This can be accomplished in a few different ways, all of which are viable options. The first mechanism for determining soldier wellness is with the use of a health bar, when the health bar drops below a certain point the soldier will no longer be able to fight effectively, and when it drops completely the soldier will have deceased, and must be removed from the battlefield. The second method for determining soldier wellness is visual cues. Soldiers will move more quickly and fire more effectively while healthy, but once injured will begin to move more slowly and display signs of injury or other obvious signs of weakness/death.

The probability of firing successfully would be determined by many contributing factors, such as weapon type, range, accuracy of line of sight, and perhaps some element of randomness to add a small degree of luck to the fight. During the battle, calculations will be made in real time to determine if shots fired land successfully or not. This real-time hit scanning will occur simultaneously for all soldiers as the battle rages. A sufficiently powerful processor to run these calculations while also displaying the visual components of the battle is required in order for the game to function properly. Similarly to modern video games, simulated weapon trajectories can be determined using real time calculations to simulate weapon fire, these calculations are well known in the art of first person shooter games.

In one embodiment, each soldier can have individual characteristics. Switching two soldiers who are of the same class may not result in exactly the same outcome, one soldier might be better at mid-range shooting than another soldier, while the other soldier has an advantage at close range shooting.

Firing animations would include simulated explosions and sounds and would work to generate a visually appealing experience. These rendered graphical effects will also help players determine if their shots are lined up properly. The virtual army men could also salute to acknowledge commands given to them and have other superfluous and unique animations to flesh out their characters and create a more engaging visual experience. The inclusion of these visual effects, along with the physical uniqueness of each soldier works to have players build an emotional connection to their soldiers.

b. Player interactions

While the battle occurs the players are free to make changes, such as adjusting orientation of soldiers to improve line of sight accuracy. These adjustments will translate into corresponding changes in the virtual world. Depending on whether the game occurs in real time or in a turn by turn iteration certain limitations may be placed on the player's ability to move soldiers so as not to gain an unfair advantage. This limitation may be incorporated so a player cannot, for example, teleport a rocket launcher equipped soldier all around the map in order to gain devastating hits on the enemy and teleport away before return fire can be made. The specific nature of the game limitations is something left up to the player. For instance, one group of players might want to allow teleporting once per minute, while another group might want to disallow teleporting altogether. In this way the specific regulations are tailored to the player, but a fair set of rules should be agreed upon beforehand.

The player's hand adds an interesting wrinkle to the virtual gameplay of the soldier game. Because the hand exists in both the real and the virtual world it can affect both spaces as a sort of mobile obstacle. If the players are so inclined, player hands could be used as mobile cover, hiding allied soldiers when being fired upon, and moving away when allied soldiers are ready to fire. Allowing this type of gameplay interference would have to be mutually agreed upon by the players beforehand.

c. Ammunition Purchases

In order to run a game of this magnitude, significant revenue would need to be generated to be put towards upkeep. Micro transactions could potentially offset these upkeep costs. In the soldier game micro transactions could be implemented in a few different ways. Allowing the player to buy ammunition in order to both generate profit and give an advantage to the player is a great way offset upkeep costs and add a layer of unpredictability to the game.

2. Fighting in real time

It is possible to run the toy soldier game in two distinct ways, one is as a turn based strategy game, and the other is as a fight in real time. Both of the two different approaches have advantages and disadvantages to the player. Fights in real time present a unique set of challenges to the player. The player will need to juggle removing wounded soldiers from the battlefield, repositioning soldiers on the fly, and strategizing to try to outmaneuver the enemy player all at the same time.

When fighting in real time, a significant challenge for the player is juggling all of the different priorities required to run a battle. One of those major priorities is the recovery of wounded soldiers. It would be reasonable that upon a soldier being indicated as wounded, it would be allowed that the player would be able to remove the soldier before it dies from its wounds. Offering an incentive to remove wounded soldiers would make sense. For example, let's say there is a real time battle going on, and a soldier becomes wounded. The player then has (for example) 10 seconds to remove that soldier from the battlefield before it succumbs to its wounds. After being recovered, the soldier could then recover in 5 minutes. Therefore, it is clearly to the player's advantage to remove wounded soldiers, but if the player only removes wounded soldiers and doesn't mind the battlefield then they will likely be outmaneuvered and defeated.

Another important priority for players in a real time battle is the movement of troops. The more often/more strategically players maneuver their troops the more likely they are to gain an advantage over the enemy force. To prevent repeatedly and infinitely moving troops from place to place, certain limitations would be placed on movement speed of soldiers to avoid unfairness, but repositioning soldiers as the battle progresses in a real time version of the game allows for a more frantic type of strategy. This is especially true when players are trying to juggle the movement of troops with the retrieval of wounded troops. While all this frantic maneuvering is occurring, the player also needs to be strategizing in order to try and out think the enemy player, not just respond to their motions. All three of these priorities would be balanced by a successful player in a real time battle in order to win a fight.

One of the major advantages of an Augmented Reality game played in the format described above is that time can be controlled by the player. At any point both players can pause and take a break, or slow down time for a more visual experience. However, if played in real time, giving players complete control over time would cause unfairness, as players would just go back and correct all their errors until the game goes on infinitely, so certain limitations would be used in the time management system to prevent the game from becoming too easy.

When playing solo, a player may try various strategies, and then move time backwards to try different strategies to see what would happen. This feature allows the player to manipulate time as a parameter for the game. Time can be slowed, reversed, and made unequal for various players. One play could be forced to play in slow motion while another is allowed to operate at double speed (perhaps to balance gameplay between an adult and a child).

3. Turn Based Fighting

The game software supports live and turn-based interaction between human users and AI users. This is unique in that the Augmented Reality content and interaction is tied to each turn in a linear format.

In this iteration each player has a turn where they are allowed to change their armies' positioning. Both players will utilize their turn in order to try and gain an edge over the other. This slower, more strategic game is somewhat less frantic and intense, but it may add a level of depth not found in real time army management. In this iteration of the game, there will be differing priorities than that of a real-time battle. In a turn based system players will prioritize resource management and troop movements.

When working with a turn based system an additional level of strategy can be incorporated into the game. In an army management game such as this one, a resource management feature would make the experience just that much more complicated and interesting. This would require players to keep armies stocked on food, weapons, and even clothing. Failure to maintain a proper supply line could result in a player's soldiers performing more poorly, or even total failure in a battle. While maintaining a supply line, the player would also need to continue to fight the battle and attempt to beat the enemy army.

4. Time Control

One of the main advantages to traditional play is that the player has complete control over the flow of time in their game. They can fast forward, rewind, or change the scenario mid game without disrupting play. The toy soldier game attempts to capitalize on that imaginary feature by incorporating time control into its own gameplay system. This means that players can fast forward, rewind, or change the scenario for the game on a whim, just like in traditional imagination based play.

When playing games of imagination, it is common that players are struck with inspiration, for example a new idea that improves upon the game. Including a rewind feature in the army game allows for players to use new strategies and incorporate them into the battles. If a key soldier fell, the player could rewind time, and change events to facilitate its survival. Slowing time is an additional way that time control can help the player have a more enjoyable experience. Slowing time can serve two purposes, on the one hand it allows the player to think through their actions and therefore play more deliberatively, and on the other it also allows for the spectating of a spectacular battle rendered in slow motion. Frequently in games of strategy and skill, one player requires a handicap. Players requiring a handicap could be granted an advantage in the ability to manipulate time to a limited degree. One example of a time handicap is that there are only a set number of time manipulations per minute allowed, giving one player a few extra time manipulations per minute would be a suitable handicap.

D. Monitoring and Manipulation of Environment

Augmented and virtual reality devices present a great opportunity for expanding the feature set of the toy soldier game. With their extreme versatility, augmented and virtual reality devices present a developer with countless possibilities. Some of the specific ideas which could be implemented in the toy soldier game are; transforming the visual representation of the battlefield into a comic book visual style, transforming the visual representation of the battlefield into a cartoon visual style, reenacting famous historical battles, and viewing the battle from a single soldier's point of view.

1. Media Modes

a. Comic Book Mode

When viewed in a comic book style the expansive and complicated battlefield information would be taken in by the Augmented Reality device. The device will then prompt the player to choose a smaller portion of the scene to capture. Once this section is chosen the device will generate a few comic style images of the scene. These scenes could then be printed out, and added to, or edited with a suite of simple editing tools before being printed. These comic book pages could be edited with effects like explosions, speech bubbles, or sound effects.

b. Cartoon Mode

Similar to generating a comic book view, the Augmented Reality device could also be used to generate a short cartoon based off of a snapshot of the battle. This is essentially a short video captured of a small section of the battlefield. This video is then taken and converted from the pseudo-3D rendering used in Virtual/Augmented Reality devices into a cartoon-y style. Note that unlike in comic book mode, the video data from the devices are not converted into stills. The player is still seeing video, though it has been turned into cartoon format. When running in cartoon mode, the player has three layers that can be viewed: the physical layer, the virtual layer, and the cartoon layer.

c. 2D Recreation of Generated Boundaries

The game software supports a unique feature that can be called 2D (two dimension) regeneration. This feature allows players to capture and recreate physical areas and then compress those into 2D views.

2. Historical Battle Reenactment

The toy soldier game can also be a vehicle to convey historical knowledge from various wars throughout history. The method for achieving this education is by pre-loading a number of famous battles from history into the Augmented Reality device. The player would have an option in the game menu to reenact a battle, and could choose from the selection of historical battles. Upon choosing a battle several things would occur to prepare for the battle reenactment. The first thing that happens is an overlay of the historical battlefield map onto the game map. In order to properly reenact a battle the environment it occurred in must first be replicated. The battlefield map will also be overlaid with contour lines, to preserve the altitude differences which sometimes played critical roles in history. In another embodiment, the terrain or geographical map could be real world terrain elements that are positioned along with the characters. The next overlay to be applied depicts where troops were placed in the historic battle, so players can choose to either perfectly replicate it with their own soldiers, or tweak it to observe a new outcome. Soldier positioning and hit scanning will operate somewhat differently than in a normal toy soldier battle. Elevation of soldier (in reference to the historical game map) will be taken into account and will have a profound effect on how well soldiers perform. The important change here is that instead of soldier elevation being based on the elevation of the features of the room it is now based off of the historical elevation of the point where the soldier resides on the map.

3. Points of View

a. First Person View

In order to gain a new perspective on how the battlefield looks, the player could simulate the viewpoint of a single soldier. This task would be best rendered by a secondary device (such as a TV screen), separate from the Augmented Reality device. This device would present an entirely different view of the battlefield, and would allow a player to orient a single soldier with extreme precision. Additionally, this new perspective could serve as an interesting strategic resource, seeing a single soldier's point of view might paint a clearer picture of how outnumbered it is when compared to trying to estimate numbers while viewing the whole battlefield.

b. Drone View

With recent developments in autonomous drone technology, one could envision an iteration of the toy soldier game utilizing a largely AI controlled drone. In this iteration of the game the player would use a virtual reality device exclusively, a dedicated augmented reality device would be unnecessary. The autonomous drone would use an equipped camera fed into the virtual reality device in order to present a new perspective of the real world (from up in the air). All of the “augmentation” normally present in the toy soldier game would be applied to the camera feed from the drone before being shown to the player using the virtual reality device's processor. In this way, the virtual reality device would be largely acting as an augmented reality device with a different-than-normal perspective.

In another embodiment, the software could simulate the view of the battle from a drone, showing the player the battle from high above the battle.

In another embodiment, a small drone could be used in the room to survey the environment and the soldiers, and the input from the drone could be used as input to the game. It is also envisioned that a drone could be used to view physical humans playing an army game in a real outdoor environment, and then use the simulation of the game to replace actual weapons. Perhaps a civil war reenactment club wanted to simulate the battle, a drone could be used to capture the placements of the soldiers before the battle and then could radio each of the players with instructions (i.e. telling a soldier that he is wounded or killed).

4. Mass Army Mode

As one iteration of the invention, a type of toy soldier game based around extremely large troop numbers could be utilized. In this iteration, due to the exceedingly large number of units, physical units would be much simpler, to the point of even being as simple as a block. So, instead of the personal experience of having each soldier be unique, the player is instead faced with large numbers of troops to manipulate as strategically as possible. Though in the physical world the troops will be very simple in design, digital renderings of the soldiers would still be applied by the Augmented Reality device. In this way, despite having very simple game pieces, the visual experience would still be preserved for the player. Each game piece could represent different quantities of soldiers. For example one game piece or marking on a piece could represent a squad (8-12 soldiers) while others could represent a brigade (3000-5000). The simple blocks would be identified by the Augmented Reality device as game pieces in one of several ways. The first of these methods of troop identification is through the use of a visual marker on each soldier (block). This visual marker is then identified by the Augmented Reality device and a soldier overlay is applied. The second method of troop identification is through object recognition technology. Because the physical block shape of the soldier is consistent across all soldiers, it is trivial for the Augmented Reality device to search for that form factor and superimpose a soldier rendering wherever one is found. Additionally, a certain piece could represent the leader of a group of soldiers. There could be additional game rules that provide for the capture or kill of the leader. The same rule based probabilistic algorithms would similarly apply to a multitude of soldiers as it does to one soldier.

E. Reset of Simulation

After a fight is completed, the events of that fight can be recounted as a video generated by the cameras viewing the battle. In this way, time can be scrolled through by the player, While viewing this scrolling history of the battle, the player is free to make alterations, and these alterations are then taken into account, causing changes to occur in the battle outcome. Additionally, players can use the time scroll feature to view the battle as it would take place with the current orientation and perspective of whatever device the player is using, giving them insight into what actions to take to produce better results.

In this video review of the battle, there are actually two separate video streams, one from the physical world and one from the virtual world. Both are important. The physical video can be used to reset the game at certain points in time and the virtual world is a movie of the virtual battle.

### III. Additional Embodiments

Technically speaking, it requires very little additional effort to adapt the toy soldier game to different types of settings. Simply changing a setting, and the physical toy set involved, to a set of dolls enacting some sort of play, or a fire truck putting out a building fire would be enough to create an entirely different experience. These experiences would share several features with the toy soldier games, such as time management, and the virtual overlays over real toys.

A. Doll house

The doll house iteration of the augmented reality game utilizes the Augmented Reality device camera and processor to perform object recognition on the dollhouse's various rooms and the dolls within it. Any classic cutaway dollhouse could be used, as long as the camera can view the rooms, but a specially designed dollhouse could communicate with the smartphone app to add additional levels of interactivity. (Such as sounds and lights in the dollhouse reacting to story elements). The dolls could also be specially designed (so that voice work can be done for the characters).

Based on the setting, and the characters present (determined by the Augmented Reality device) the device would then randomly generate a story to be visualized to the user. The story could be played out using a short video generated using the device's processor or a vocal piece using either computer generated vocals or extensive vocal recording, or even just a written paragraph laid out on the phone screen for the children to enact.

The focus of the augmented reality dollhouse game is the interaction of dolls with an electronic device. The device will view the dolls through some form of camera, and their positions would be processed and a story would then be generated. Then the dolls would come to life on any TV, IPad, IPhone, Kindle, etc. that is connected. The dolls could be microchipped, or have their positions determined using object recognition technology. After they are scanned, the dolls can be customized by changing clothing or being denoted with user-chosen names. While filling out name information, the player could also add relationship information with regard to the other dolls present in the scene. This would influence how the dolls acted towards one another, for example if there were three dolls, one was denoted as an acquaintance, one was denoted as the mother, and one was denoted as the daughter. The mother could act out in a stereotypical (or non-stereotypical) motherly way while the other two characters might be watching TV or playing outsides. When that scene is finished playing out the player can save the setup to help set it up like that again at a later date, and, could also save the “story” or what happened during that day.

There are many different ways the dolls could be designed. Dolls that look generic with random colors of hair, eyes, and outfits could be packaged and sold. Famous dolls that are characters from movies or other media could also be packaged and sold as sets. Dolls could also be based off of actors and actresses. Additionally, dolls could be made custom (or generic dolls appearances could be customized to match the player's features in the rendered scene. Additional doll options could be pets such as cats, dogs, horses, or others.

B. Fire Trucks

In this iteration a toy fire truck would be overlaid by an Augmented Reality device in order to appear to have active sirens or to be actively firefighting some of the terrain around it. In addition, firefighters could be rendered to serve as a crew for the fire truck. The toy could recognize which direction the hose is facing, and then render water being shot out of the hose in that direction. The aim of the hose could impact whether the fire is extinguished.

C. City Management/Construction

Construction crews could be brought to life in order to appear to actively be working on building/repairing a city. The buildings could be rendered, and not actually physically exist in any way (to avoid excessive messiness). Or you could have a pre-built building which reacts to the toy construction workers' activities in some way

D. Tanks, Ships

One of the simplest transfers from toy soldiers is a translation into an artillery fight, such as with tanks, or a naval battle with ships. All features from the toy soldier game could be preserved in these iterations.

E. Trucks

Playing with trucks could also be improved from augmented reality technology. Truck payloads could be rendered in, and drivers could be animated in the driver's seat as well.

F. Invasion Scenario

An attacking army could be moving toward you and you have to position your soldiers to defend your military base or a village from a hoard of zombies or knights defending a castle. The impending attack would be known in advance and you could use strategic positioning to simulate the defense. The game could be static where once the characters are positioned the scenario plays itself out without additional configuration. In another embodiment the user could move the characters around while the invasion or battle is taking place.

### IV. Implementation

At its core the game software is about integrating the real world and virtual world at a deeper level than has previously been achieved. The system uses machine learning, depth sensors, and object recognition to discern physical and material properties about the real world, not just its shape. These properties are then utilized by the virtual counterpart in order to be able to generate a virtual space that not only looks the same way as the real world, but also one that acts in the same way.

The game software has countless applications including, but not limited to: Virtual Reality gaming, competitive sports telemetry, modeling simple physical interactions, and various industrial applications.

The software as applied to virtual reality gaming would offer several advantages over current systems. Suppose the game software was applied to an augmented reality game. Current technologies allow for object recognition at the surface level. Determining only shape and other positional factors. The software would be able to take the object recognition a step further and discern additional properties. This would translate (in game) to an experience where the player can see interactions between physical objects and digital objects, rather than just viewing them as a static backdrop to the game they are playing.

When one competes, no matter the manner of competition, the information they have access to plays a vital role in their performance. Being able to make physical discernments about the world offers those who need an edge access to extremely valuable environmental telemetry. Suppose, for example, a snowboarder competing to be the first down the mountain is using the software. The system could discern and outline the fastest route down the mountain. This information would not only be based on the pitch of the slope and the shortest route, it could also draw information regarding snow composition to keep the competitor from inadvertently hitting a hard to spot patch of ice. These useful bits of telemetry would change the face of professional competition.

Modeling of simple physical interactions between objects is a well-developed field. However, with the introduction of the virtual representations of these models can be overlaid on the real world in a way that is previously unheard of. Never before has someone been able to see a thrown ball's expected trajectory superimposed digitally in real space and in real time. This particular ability is nearly limitless in its applications in everyday life.

Industrial applications can benefit from the invention as organizations are starting to adopt emerging technology to add new business value and gain efficiencies to transfer knowledge to the new workforce. This invention can be beneficial to the enterprise in terms of providing an additional layer of physical and digital interaction on the factory floor and within industrial settings.

In one embodiment, this invention aims to be a standard for intelligently discerning material properties of physical objects through the use of machine learning and advanced object recognition algorithms.

The game software is a system that translates interaction and physics properties from physical objects in the real-world into physics properties and intractable objects in digital form.

The software uses RGB-D (red, green, blue, depth) sensors to collect and then algorithmically determine digital properties from physical depth and color information.

The software leverages a proprietary and smart-learning algorithm to learn from determinations of physical to digital translations.

The game algorithm gathers hardware spatial data and converts this data into a proprietary format compatible with industry standard data transmission formats (JSON, XML, ASCII, etc.). This format can be ingested by other third party database platforms and linked with application programming interfaces (API) as a connection into the spatial converted stream of physical information and digital counterpart property creation.

Digital objects are recreated within a 3D rendering engine and the physical properties created from the algorithm are applied to the digital counterparts.

The game algorithm will dynamically relocalize digital representations of physical objects and recalculate digital variables based on physical interaction and actions that happen to the physical environments.

The software retrieves information from multiple public data sources for texture and physics properties. The software stores and retrieves information from proprietary data sources for texture and physics properties.

The algorithm translates physical properties into digital counterparts called Spatial Variables. These variables include mass, drag, angular drag, gravity, position, rotation, scale, collider boundaries, material, dynamic friction, bounce, density, velocity, acceleration, texture, health, visibility settings, success factors, and distance in world coordinates. The software also supports dynamic and custom physical-to-digital property mapping. These custom variables can be created and mapped directly within the technical data exchange layer or managed through external API and 3rd party applications.

The software employs a technical connection between the physical space and digital application layers. Digital application layers can be defined as software applications that display data to end users. This form of display can be on mobile device screens, computer screens, terminals and wearable devices. This software is unique over previous teachings in that the data provided from physical mapping is format and user-interface agnostic from a consumption standpoint. This user-interface agnostic approach allows for current and future scalability in terms of the hardware devices that can be leveraged to interact with the physical data mapped into digital counterparts.

The software employs a technique called physical object property mapping where the shape, size and material of the physical object or capture-space is collected and processed from RGB-D format into a lightweight, spatial model for haptic and digital response and input feedback. This physical object property mapping algorithmic process is a machine learning algorithm that can be updated with additional logic and information from remote applications servers.

The software will employ continuous or asynchronous mapping during run-time intervals. Through this feature, the game software is able to provide a continuous feed of information from the real world and physical objects into the digital world for immersive interaction. This continuous spatial stream can be leveraged for ongoing digital and haptic feedback with digital counterparts.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. An apparatus for playing an augmented reality game, the apparatus comprising:
one or more physical characters containing attributes, wherein the physical characters are placed in real-world positions,
a reality-altering device comprising:
one or more cameras for viewing the physical characters, the attributes, and the real-world positions,
a processor, utilizing specialized software, that collects the metadata from the one or more cameras and renders the physical characters, the attributes, and the real-world positions into a 3D virtual game environment,
a screen for viewing the 3D virtual game environment,
wherein the reality altering device uses probabilistic outcome algorithms to simulate virtual animation of the physical characters on the screen.

2. The apparatus of claim 1 wherein the one or more physical characters are toy soldiers

3. The apparatus of claim 1 wherein the attributes include character costumes.

4. The apparatus of claim 2 wherein the toy soldiers carry weapons and are positioned in a battle simulation.

5. The apparatus of claim 1 wherein the attributes of the characters can be changed digitally on the reality altering device.

6. The apparatus of claim 1 wherein the attributes include weapons.

7. The apparatus of claim 1 wherein the physical characters contain a processor allowing the character to be configured digitally in the 3D virtual game environment.

8. The apparatus of claim 1 wherein the physical characters fulfill a particular role in the virtual reality game.

9. The apparatus of claim 1 wherein the reality altering device further allows time to manipulated.

10. The apparatus of claim 9 wherein time is moved backwards to allow the simulated virtual animation to recreate the animation using different real-world positions of the physical characters.

11. An apparatus for playing an augmented reality game, the apparatus comprising:
one or more physical game pieces having physical markers, wherein each game piece represents a multitude of characters having attributes,
A reality-altering device comprising the following:
one or more cameras for viewing the physical game pieces and the attributes,
a processor, utilizing specialized software, that collects the input from the one or more cameras and renders the physical game pieces and the attributes into a 3D virtual game environment,
a screen for viewing the 3D virtual game environment,
wherein the reality altering device simulates virtual animation of the physical characters on the screen based on the physical game pieces, the attributes, and the real-world positions and using probabilistic outcome algorithms.

12. The apparatus of claim 11 wherein the one or more physical characters are toy soldiers.

13. The apparatus of claim 11 wherein the attributes include character costumes.

14. The apparatus of claim 11 wherein the one or more game pieces can represent different sizes of soldier formations.

15. The apparatus of claim 11 wherein the attributes of the characters can be changed digitally on the reality altering device.

16. The apparatus of claim 11 wherein the attributes include weapons.

17. The apparatus of claim 11 wherein the one or more game pieces contain a processor allowing the character to be configured digitally in the 3D virtual model.

18. The apparatus of claim 11 wherein the physical characters fulfill a particular role in the virtual reality game.

19. The apparatus of claim 11 wherein time can be changed digitally on the reality altering device.

20. A method for playing an augmented reality game, the method comprising:
detecting one or more attributes of physical characters, wherein the physical characters are placed in real-world positions,
transforming the physical characters into a 3D virtual game environment, provided by the following steps:
viewing the physical character, the attributes, and the real-world positions with one or more cameras,
processing, utilizing specialized software, metadata from the one or more cameras provided by the attributes and the real-world positions,
rendering the physical characters, the attributes, and the real-world positions into the 3D virtual game environment,
viewing the 3D virtual game on a screen,
simulating a virtual animation of the characters on the screen using a probabilistic outcome algorithm.

21. The method of claim 20 wherein the one or more physical characters are toy soldiers.

22. The method of claim 20 wherein the attributes include character costumes.
